(19) United States
(12) Patent Application Publication
(10) Pub. No.: US 2011/0240933 A1
(43) Pub. Date: Oct. 6, 2011

(54) Process for producing a component layer for organic light emitting diodes

(75) Inventors: Kisuck Jung, Pusan (KR); Sangmin Han, Pusan (KR); Hyunsuk Jeong, Pusan (KR); Iljo Choi, Pusan (KR); Dongyoon Kim, Gyeongsangnam-do (KR); Eunha Jeong, Ulsan (KR)

(73) Assignee: SOLVAY SA, Brussels (BE)

(21) Appl. No.: 13/133,578

(22) PCT Filed: Dec. 8, 2009
(86) PCT No.: PCT/EP2009/066586

§ 371 Date: Jun. 8, 2011

(30) Foreign Application Priority Data
Dec. 23, 2008 (EP) 08172712.5

(51) Int. Cl. C09K 11/02; H01B 1/12; C09K 11/06; H01B 1/22

(52) U.S. Cl. 252/519.21; 252/500; 252/301.16; 252/301.35

(57) ABSTRACT

The present invention pertains to a method of preparing a component layer for organic light emitting diodes involving milling a composition comprising: at least one component material selected from the group consisting of hole transporting materials, electron transporting materials, hole injection materials, electron injection materials, and emitting materials; a solvent; and a binder. It has been found that, when milling is used for the preparation of a dispersion or suspension, the surface quality of the resultant component layer can be improved, thereby significantly improving the performance of the organic light emitting device. The present invention also provides organic light emitting devices including the component layer prepared by the above preparation method.

The present application claims the benefit of the European application no. 08172712.5 filed on Dec. 23, 2008, herein incorporated by reference.

### TECHNICAL FIELD

The present invention relates to a process for preparing a component layer for organic light emitting diodes based on milling. The present invention further relates to a light-emitting device having a component layer prepared by such process.

### BACKGROUND

Currently, various display devices are actively being researched and developed, particularly those based on electroluminescence (EL) from organic materials. Contrary to photoluminescence (i.e., light emission from an active material due to optical absorption and relaxation by radioactive decay of an excited state), EL refers to a non-thermal generation of light resulting from applying an electric field to a substrate. In the case of EL, excitation is accomplished by recombining the charge carriers of opposite signs (electrons and holes) injected into an organic semiconductor in the presence of an external circuit.

A simple prototype of an organic light-emitting diode (OLED), i.e., a single layer OLED, is typically composed of a thin film made from an active organic material, which is sandwiched between two electrodes. One electrode needs to be semitransparent in order to observe the light emission from the organic layer. Typically, an indium tin oxide (ITO)-coated glass substrate is used as an anode.

For fabrication of a thin film from active organic materials, deposition is primarily performed through a vapor or solution phase process. Vacuum deposition is used for small molecules and oligomers and is somewhat costly because of the expensive equipment and low deposition throughput, but produces films with high field-effect mobility and on/off ratios. Examples of organic material films that have been deposited using this method are oligothiophene and oligofluorene derivatives, metallophthalocyanines, and acenes such as pentacene and tetracene.

Vacuum deposition/pattern processes widely used in OLED manufacturing processes are more expensive than solution processes, such as printing, ink-jet, and spin-coating, and are not appropriate for manufacturing wide area glass panels over 17 inches because the middle of the wide area glass panel is bent during its manufacturing process. Accordingly, the solution process has been studied since it may overcome the above-noted problems of the vacuum deposition/pattern process and increase the efficiency of a device.

For solution-soluble organic semiconductors, two forms of deposition are available: deposition of a soluble precursor of the organic semiconductor from a solution followed by a subsequent conversion to the final film or a direct deposition from solution. The motivation for using soluble precursors is that most conjugated oligomers and polymers are insoluble in common solvents unless side chain substitutions are incorporated into the molecular structures. The addition of side chains can interfere with molecular packing or increase the π-π stacking distance between molecules, decreasing the mobility of charge carriers, but, when used properly, can be incorporated to promote better molecular packing, as in the case of regioregular poly(3-hexylthiophene) (P3HT). However, determining the processing temperature can be challenging, as the conversion temperature from precursor to semiconductor may be too high for compatibility with low-cost plastic substrates. Furthermore, the conversion of the precursor to the corresponding semiconductor requires at least one additional processing step.

Spin-coating and solution casting are two common methods of direct solution deposition and are often used for polymers, such as regioregular P3HT or various soluble oligomers. Further, small molecules, such as phthalocyanine-based materials, have been used in wet processes, such as spin coating and solvent-casting techniques.

U.S. Pat. Nos. 3,775,149, 4,371,642, 5,716,435, and 5,859,237 and PCT International Publication No. WO 05/123844A1 disclose various processes of producing pigments, such as phthalocyanines and dispersions thereof, by milling with milling media or kneading. For example, U.S. Pat. No. 3,775,149 discloses a process in which a phthalocyanine pigment is produced by at least 80 percent in the beta-pigmentary form by grinding a dispersed suspension of crude pigment in an aqueous medium preferably with particulate grinding elements which are insoluble in an aqueous medium containing from 5 to 10 percent of a surface active agent until the pigment flocculates.

U.S. Patent Application Publication No. US 2001/009691A and U.S. Pat. No. 6,023,371 disclose a method for creating a display device involving depositing ink comprising a fluorescent dye and a host matrix by ink jet printing over a substrate, as well as various fluorescent dyes and host matrix, such as polymethylmethacrylate (PMMA), polybutadiene, etc. U.S. Pat. No. 6,087,196 also describes a process for forming a pattern on a substrate by depositing organic material in a solvent by ink-jet printing and discloses depositing polyvinylcarbazol film and light-emitting dyes in a solvent onto a substrate by ink-jet printing, as well as a process for controlling concentrations of their solution appropriate for ink-jet printing. In U.S. Patent Application Publication No. US 2004/097101A, various materials, such as copper phthalocyanine, tris-(8-hydroxyquinoline)aluminium (Alq₃), etc., are disclosed as light emitting materials for forming organic layers using a solvent process, such as ink-jet printing and spin-coating.

Other types of materials, such as conducting polymers, have also been studied. U.S. Pat. No. 6,366,017 and U.S. Patent Application Publication Nos. US 2003/054579A, US 2003/222250A, US 2005/029932A and US 2007/031700A disclose various examples concerning spin-coating of an emitting material, such as polyphenylenevinylene derivatives (e.g., MEH-PPV), and a conducting polymer to prepare an emissive layer. However, the examples utilize only the dissolution of the emitting material, in particular, polymeric materials to a solvent, without utilizing milling to prepare solutions/dispersions of emitting materials.

Other patents, such as Japanese Patent Laid-Open Publication Nos. JP2007157349A2, JP2007207591A2, JP2007207592A2, and JP2007207593A2 and Chinese Patent Publication No. CN1819303A, also disclose various structures of organic light-emitting diodes and their component layers obtained by dissolution of soluble materials (such as MEH-PPV) or mixing conductive polymers and small molecules for doping.

However, the preparation of a suspension or dispersion of small organic materials is difficult and sometimes inappropriate for the preparation of high quality film for OLED devices. It would thus be desirable to develop a process for preparation of such suspension or dispersion, which can meet all of the above requirements.

### BRIEF DESCRIPTION OF THE DRAWINGS

FIG. 1 is a cross-sectional view of a display device containing the organic light emitting device of the present invention.

FIG. 2 is a front view of a paint shaker.

FIG. 3 shows a schematic representation of a spin coating process using the dispersion of the present invention.

### DETAILED DESCRIPTION OF THE INVENTION

The present invention relates to a method of preparing a component layer for organic light emitting diodes, which can lead to an improvement in surface qualities of the resultant layer, as described below.

The present invention provides a method of preparing a component layer for organic light emitting diodes involving milling a composition comprising at least one component material selected from the group consisting of hole transporting materials, electron transporting materials, hole injection materials, electron injection materials, and emitting materials, a solvent, and a binder.

The present invention especially provides a method of preparing a component layer for organic light emitting diodes comprising milling a composition comprising:
(a) at least one organic component material selected from the group consisting of hole transporting materials, electron transporting materials, hole injection materials, electron injection materials and emitting materials,
(b) a solvent, and
(c) a binder,
   wherein said milling is carried out in at least two steps in which:
(i) the binder is first milled with the solvent and
(ii) the component material is added

In one embodiment of the present invention, the component material is added to the mixture resulting from step (i) while continuing the milling. In said first embodiment, the milling is conducted in at least two steps in which (a) the binder is first milled in a solvent in the presence of a milling medium and then (b) at least one component material selected from the group consisting of hole transporting materials, electron transporting materials, hole injection materials, electron injection materials, and emitting materials is added while the milling is being continued.

In another embodiment, the milling conducted in step (i) is stopped, the component material is added to the milled mixture of step (i) and the resulting mixture is further milled. In said second embodiment, the milling is carried out in at least three steps in which (a) the binder is first milled in a solvent in the presence of a milling medium, (b) at least one component material as described above is added to form a mixture, and then (c) the resulting mixture is milled further.

In some specific embodiments, following steps (i) and (ii), additional steps of diluting and repeating the milling can be carried out until the viscosity of the milled mixture is in the range of from about 1 to about 50 cp.

In another embodiment of the present invention, the diluting and repeating the milling are further conducted until the viscosity of the milled mixture is suitable for spin-coating, and the mixture is spin-coated to prepare a component layer.

In the present invention, the component material is preferably an organic component material.

For the binder, it is preferable to make a selection from materials that do not extinguish fluorescence, especially materials that can be finely patterned by screen printing, photolithography, or the like. In a preferred embodiment of the present invention, the binder is a polymeric material, specifically a conductive polymeric material, more specifically a polymer selected from the group consisting of polymers made of monomers containing a vinyl group such as poly(vinyl butyral); an alcohol group such as poly(ethylene glycol); an acrylate group such as poly(methyl methacrylate), poly(acrylate), poly(acrylonitrile); a phthalate group such as poly(ethylene terephthalate); a sulfide group such as poly(sulfone), poly(1,4-phenylsulfide); a styrene group such as poly(styrene-co-butadiene); a conjugated double bond and mixtures thereof; and copolymers thereof; and mixtures thereof.

As for the solvent, the organic solvent used herein may be selected from known suitable organic solvents depending on the binder used and the component material to be dissolved therein. For instance, use may be made of halogenated solvents, such as monochlorobenzene, methylene dichloride, ethylene dichloride, 1,2-dichlorobenzene, and tetrachloromethane; heterocyclic solvents, such as dioxolane and tetrahydrofuran; alcohols, such as methanol, ethanol, propanol, octanol, isopropylalcohol, and phenol; ketones, such as cyclohexanone, methylethylketone, acetone, methyl isobutyl ketone, and N-methylpyrrolidone; acetates, such as propylene glycol methyl ether acetate (PGMEA) and ethylacetate; aromatic solvents, such as toluene and benzene; amines, such as triethylamine, isopropylamine, and aniline; hydrocarbons, such as hexane and cyclohexane; amides, such as N,N′-dimethylformamide; nitriles, such as acetonitrile.

Examples of the component layers include a hole injection layer (HIL) comprising a hole injection material (HIM), a hole transporting layer (HTL) comprising a hole transporting material (HTM), an emissive layer (EML) comprising an emitting material (EM), an electron transporting layer (ETL) comrprising an electron transporting material (ETM), and an electron injection layer (EIL) comprising an electron injecting material (EIM). The emissive layer, or light emitting layer, has the function of injecting holes and electrons, transporting them, and recombining them to create excitons (which leads to the light emission). The hole injecting layer, which is sometimes referred to as a charge injecting layer, has the function of facilitating the injection of holes from the anode, whereas the hole transporting layer, which is often called a charge transporting layer, has the function of transporting holes and blocking electron transportation. When the compound used in the light emitting layer has a relatively low electron injecting and transporting function, an electron injecting and transporting layer having the function of facilitating the injection of electrons from the cathode, transporting electrons, and blocking hole transportation may be provided.

As for the hole conducting emissive layer, one may have an exciton blocking layer, notably a hole blocking layer (HBL) between the emissive layer and the electron transporting layer. As for the electron conducting emissive layer, one may have an exciton blocking layer, notably an electron blocking layer (EBL) between the emissive layer and the hole transporting layer. The emissive layer may also play the role of the hole transporting layer (in which case the exciton blocking layer is near or at the anode) or of the electron transporting layer (in which case the exciton blocking layer is near or at the cathode).

Some compounds used in one component layer can act differently in other component layers of organic emitting diodes depending on their work function. For example, Alg₃ has been used as a green emitter but it can simultaneously be used in an electron-transport layer in some blue-emitting organic devices.

For the emitting material, it is preferable to use those having a high fluorescent quantum efficiency and stability to both electron and hole carriers. The emitting material may be at least one selected from the group consisting of (A) metal complexes, such as 8-hydroxyquinoline metal complexes and Ir complexes; (B) fluorescent organic dyes, such as hydrocarbons having fluorescent moieties; and (C) conducting polymers. Specifically, the emitting materials of family A may be at least one selected from Alg₃ or its derivatives, where q refers to 8-hydroxyquinolate and Ir complexes; the emitting materials of family B may be at least one selected from 4,4′-bis(2,2-diphenyl-ethen-1-yl)diphenyl (DPVBi), Coumarin 6, and perylene; and the emitting materials of family C may be at least one selected from polyphenylenevinylene, polythiophene and derivatives thereof. For some emitting materials, an additional purification step, such as vacuum-sublimation, may be carried out for better purity.

A layer formed of an electron transporting material is advantageously used to transport electrons into the emissive layer containing the light emitting material and the (optional) host material. The host material refers to a host matrix which may exist in the hole or electron transporting layer for layer formation, such as inert polymers, for example polymethylmethacrylate (PMMA) or polybutadiene. The electron transporting material may be an electron-transporting matrix selected from the group consisting of metal quinoxolates (e.g., Alq₃, Liq), oxadiazoles, and triazoles. An example of an electron transporting material is tris-(8-hydroxyquinoline)aluminium of formula [“Alq₃”].

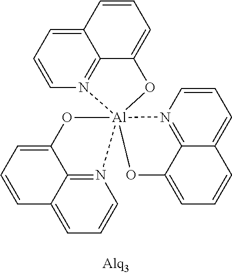

A layer formed of a hole transporting material is advantageously used to transport holes into the emissive layer containing the above-described light emitting material and the (optional) host material. Examples of a hole transporting material are 4,4′-bis[N-(1-naphthyl)-N-phenylamino]biphenyl [“α-NPD”], and 4,4′,4″-tris[N-(1-naphthyl)-N-phenylamino]triphenylamine (TNATA).

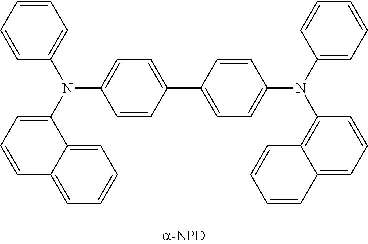

As for hole-injection materials, any material having a hole-injection function can be used. Specifically, the hole injection material is selected from copper phthalocyanine (CuPc), 4,4′,4″-tris[3-methylphenyl(phenyl)amino]triphenylamine (MTDATA), and 4,4′,4″-tris[N-(1-naphthyl)-N-phenylamino]triphenylamine (TNATA) which may also be used in a hole transporting layer, more specifically CuPc.

As for electron-injection materials, any material having such electron-injection function can be used. Specifically, the electron injection material may be selected from BaO, SrO, Li₂O, LiCI, LiF, MgF₂, MgO, and CaF₂.

In another embodiment of the present invention, the composition further includes at least one compound selected from the group consisting of CuPc, aromatic amines, distyryl arylene derivatives (DSA), naphthalene, polythiophene and its derivatives, perylene and perylene derivatives, poly(p-phenylenevinylene) and its derivatives, poly (9-vinylcarbazole) (PVK), oxadiazole and its derivatives, and triazoles.

Such emitting materials, hole transporting materials, electron transporting materials, hole injection materials, and/or electron injection materials are preferably dispersed in a binder and an organic solvent to be described later, and should be slightly soluble in the binder and organic solvent, accordingly. The proportion of the binder and organic solvent occupied by the emitting material is about 1 to 80% by volume, specifically about 10 to 60% by volume, and more specifically about 20 to 40% by volume.

For preparation of a dispersion or suspension of emitting materials, hole transporting materials, electron transporting materials, hole injection materials, and/or electron injection materials, milling is employed in the present invention. Ball milling is specifically used, preferably in the presence of inorganic balls, such as zirconia or glass balls. The particle size of the inorganic balls is typically 1 μm˜10 mm, specifically 5 μm˜5 mm, most specifically 0.01 mm˜2.0 mm. Milling may be carried out in any appropriate milling device, such as a paint shaker. The milling can be conducted at a temperature of from about 0 to about 100° C., specifically from about 20 to about 80° C., more specifically from about 40 to about 50° C., most specifically the refluxing temperature of methylene dichloride, for about 10 min to about 12 hours, specifically about 1 to about 8 hours, most specifically about 2 to about 4 hours.

After ball-milling, the resultant dispersion or suspension is tested to identify whether it is suitable for spin-coating. Even though any conventional method may be used for the identification, preferred methods include a filter test in which the dispersion or suspension is filtered through a micro-filter; a preliminary coating onto ITO glasses using the dispersion or suspension; or measurement of its viscosity.

For typical spin coating, the dispersion or suspension has preferably a viscosity of 1.0˜50 cp, more preferably 5-25 cp, most preferably 5-15 cp. The viscosity of the resultant dispersion or suspension can be controlled by dilution with a suitable solvent and repeating the milling procedure.

If the dispersion or suspension obtained from the milling and any subsequent procedure(s) is appropriate for the coating process, it may be coated onto a substrate, specifically indium-tin oxide (ITO)-coated substrates, to form a component layer(s). The coating processes used herein include a bar coating process, a roll coating process such as a gravure or reverse coating process, a doctor or air knife process, a nozzle coating process, and a spin coating process, all known in the art. Specifically, the coating process used herein includes a spin coating process.

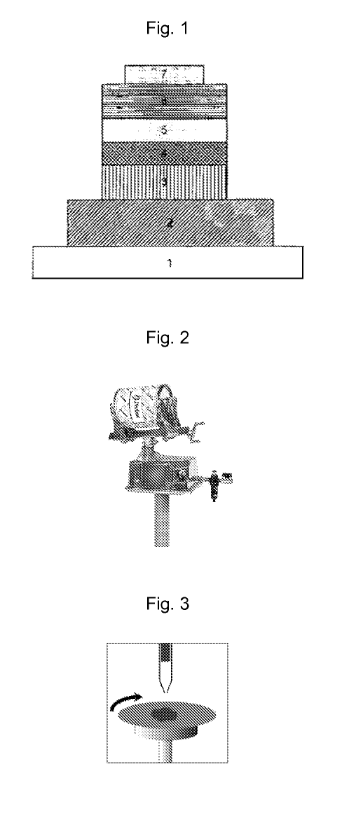

After the coating process, the resultant component layer coated on the ITO glass prepared by the present invention shows good surface quality, which was observed by scanning electron microscope (SEM) or atomic force microscope (AFM), which meets the requirements for fabricating OLED devices. The multilayer structure of the OLED device having the component layers may be prepared. Specifically, the OLED has a multilayer structure, as depicted in FIG. 1, where: 1 is a glass substrate; 2 is an ITO layer (anode); 3 is a HIL layer comprising CuPc; 4 is a HTL layer including NPD or 2-TNATA; 5 is an EML including DPVBi and a binder; 6 is an ETL including Alga; and 7 is an Al layer (cathode).

Excellent results on the surface quality (e.g., roughness) of the component layer obtained by the preparation method of the present invention can be obtained, where the OLED device using the component layer of the present invention showed better performance over that having a component layer prepared by different methods such as a vacuum-deposition technique.

The present invention also relates to the use of the component layer of the present invention for fabrication of an OLED.

Other aspects of the present invention relate to a component layer prepared to the method of the present invention, to an OLED comprising the same component layer, and a display device including the above OLED.

### EXAMPLES

### Example 1

Copper phthalocyanine (CuPc), Alg₃, NPD, 2-TNATA, and DPVBi were purchased or synthesized by well known methods and were purified by sublimation which was carried out in a sublimator. The electroluminescence efficiency (measured in cd/A) and the power efficiency (measured in Im/W) are determined as a function of brightness, calculated from current/voltage/brightness characteristic lines from an EL/PL spectrophotometer.

### 1. Preparation of Dispersions of Component Materials

Polyethylene glycol having a weight-average molecular weight of 20,000 as a binder and tetrahydrofuran as a solvent were added in a polyethylene bottle containing zirconia beads having particle sizes of 0.01 mm to 2.0 mm. In a paint shaker, the first milling was conducted for 2 to 4 hours, and then the purified copper phthalocyanine (CuPc) was added and the second milling was further conducted for 2 to 4 hours. During the second milling, a small amount of the mixture was sampled to measure the adaptability to the subsequent spin-coating process by a filter test using a microfilter. If the viscosity was too high (>50 cp), an additional amount of the solvent was further added and then the mixture was further milled for 2 to 4 hours. Also, the particle size of the dispersion was measured by zeta-potentials. The dispersion of CuPc having a viscosity of 5 to 15 cp was obtained.

Dispersions of Alg₃, NPD, 2-TNATA, and DPVBi were also prepared in an identical manner to the CuPc dispersion.

### 2. Spin Coating for Forming a Component Layer

The CuPc dispersion was spin-coated at a thickness of 0.1˜0.2 μm onto ITO glasses. After drying the obtained layer, the surface roughness of the coating was observed by SEM or AFM.

Onto the dried CuPc layer, a NPD layer was formed using a NPD dispersion (as prepared above) by spin coating followed by drying. DPVBi and Alga layers were formed sequentially on the NPD layer, and finally an aluminum layer was formed by vacuum deposition of aluminum to fabricate an OLED device having the layers of a ITO-coated substrate/HIL/HTL/EM/ETL/aluminum.

### Comparative Example 1

The dispersion of copper phthalocyanine (CuPc) is prepared as in Example 1, except polyethylene glycol, tetrahydrofuran and copper phthalocyanine (CuPc) were added simultaneously. The dispersion has poor (dispersion) stability and could not been coated onto a substrate due to sedimentation.

### Comparative Example 2

An OLED device is fabricated as in Example 1, except the hole transporting layer (HTL) is formed by vacuum deposition of NPD. The OLED device exhibited lower efficiency (by approximately 33%) compared to that fabricated in Example 1.

### Examples 2-5

Component layers were prepared as in Example 1 with the exception that the following binders and solvents were used instead of polyethylene glycol and THF, respectively.

| Example No. | Binder | Solvent |
|---|---|---|
| 2 | polythiophene | Dioxolane |
| 3 | PMMA | Cyclohexanone |
| 4 | poly(p-phenylene | Methylene |
| | vinylene) | dichloride/MCB |
| 5 | polythiophene | NMP |

The OLED devices prepared in Examples 2-5 showed comparable performances to that prepared in Example 1.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

1. A method of preparing a component layer for organic light emitting diodes comprising milling a composition comprising:
(a) at least one organic component material selected from the group consisting of hole transporting materials, electron transporting materials, hole injection materials, electron injection materials and emitting materials,
(b) a solvent, and
(c) a binder,
wherein said milling is carried out in at least two steps in which:
(i) the binder is first milled with the solvent, and
(ii) the component material is added.

2. The method according to claim 1 wherein the component material is added to the mixture resulting from step (i) while continuing the milling.

3. The method according to claim 1 wherein the milling conducted in step (i) is stopped, the component material is added to the milled mixture of step (i) and the resulting mixture is further milled.

4. The method according to claim 1, further comprising:
diluting with the solvent and repeating the milling until the milled mixture has a viscosity of from 1 to 50 cp.

5. The method according to claim 4 further comprising: spin-coating the milled mixture to prepare a component layer.

6. The method according to claim 1, wherein the binder is a polymeric material selected from the group consisting of: polymers made of monomers containing a vinyl group; an alcohol group; acrylate group; a phthalate group; a sulfide group; a styrene group; a conjugated double bond and mixtures thereof; copolymers thereof; and mixtures thereof.

7. The method according to claim 1, wherein said milling is ball milling carried out in the presence of zirconia or glass balls as milling medium.

8. The method according to claim 1, wherein the emitting material is at least one metal complex, preferably a metal complex selected from Alg₃ and its derivatives, wherein q refers to 8-hydroxyquinolate, or Ir complexes.

9. The method according to claim 1, wherein the emitting material is at least one fluorescent organic dye, preferably a fluorescent organic dye selected from 4,4′-bis(2,2-diphenyl-ethen-1-yl)diphenyl (DPVBi), Coumarin 6, and perylene.

10. The method according to claim 1, wherein the emitting material is at least one conducting polymer.

11. The method according to claim 1, wherein the hole injection materials are phthalocyanine based materials.

12. The method according to claim 8, wherein the metal complex is selected from Alg₃ and its derivatives, wherein q refers to 8-hydroxyquinolate, or Ir complexes.

13. The method according to claim 9, wherein the fluorescent organic dye is selected from 4,4′-bis(2,2-diphenyl-ethen-1-yl)diphenyl (DPVBi), Coumarin 6, and perylene.

14. The method according to claim 10, wherein the conducting polymer selected from polyphenylenevinylene, polythiophene, and derivatives thereof.

15. The method according to claim 11, wherein the phthalocyanine based material is copper phthalocyanine (CuPc).
